(19) United States
(12) Patent Application Publication
(10) Pub. No.: US 2006/0070667 A1
(43) Pub. Date: Apr. 6, 2006

(54) Anti-siphonable inlet check valve

(76) Inventors: Scott C. Gaynor, Mauldin, SC (US); Wade V. Williams, Greenville, SC (US)

Correspondence Address: DORITY & MANNING, P.A., POST OFFICE BOX 1449, GREENVILLE, SC, 29602-1449, US

(21) Appl. No.: 10/959,358

(22) Filed: Oct. 6, 2004

(51) Int. Cl. B65B 1/04; F16K 15/06

(52) U.S. Cl. 137/592

(57) ABSTRACT

An anti-siphon device for an inlet check valve includes a plurality of contoured ribs, which prevent a siphoning hose from entering a fuel tank interior through the inlet check valve. Moreover, the ribs permit liquid fuel to pass substantially unimpeded such that an adverse pressure change is not induced in the inlet check valve.

### FIELD OF THE INVENTION

This invention relates to a valve assembly for a vehicle fuel tank filler neck. More particularly, the invention is directed to an inlet check valve assembly for preventing a siphoning device from contacting a liquid fuel in a fuel tank via the vehicle fuel tank filler neck.

### BACKGROUND OF THE INVENTION

Many conventional vehicles are equipped with filler necks that allow insertion of pump lines or siphon hoses through the filler necks to siphon liquid fuel from the fuel tanks of the vehicles. Siphoning is useful in situations where the fuel tank must be purged before beginning some types of maintenance, for instance, to reduce weight before removing and repairing or replacing the tank itself.

An increasing number of modern vehicles utilize flexible (“flex”) fuel containing an alcohol mixture. For instance, a flex-fueled vehicle (FFV) (also called a variable fuel vehicle) has a single fuel tank, fuel system, and engine. The FFV vehicle is designed to run on unleaded gasoline and alcohol fuel (usually ethanol) in any mixture. The engine and fuel system in the FFV vehicle must be adapted to run on alcohol fuels because these fuels are corrosive. A special sensor is typically installed in the fuel line to analyze the fuel mixture and control fuel injection and timing to adjust for different fuel compositions.

U.S. Federal Motor Vehicle Safety Standards (FMVSS) regulation 301 prohibits siphoning flex fuel via conventional siphon hoses in order to avoid contaminating the flex fuel and the FFV fuel system, and to prevent fire hazards. However, ordinary bars, rods or screens installed in filler necks to block siphon hoses can adversely affect operation of the FFV engine and fuel system.

High-profile bars, for example, can adversely affect pressure in inlet check valves and can cause premature filling shut-off. Typical screens can be easily separated from filler necks by siphon hoses or due to vehicle vibration. Once dislodged, these screens can damage or completely block the inlet check valves.

A device is needed in the fuel tank valve industry that prevents siphoning of fuel from a filler neck that does not adversely affect pressure phenomena in the filler neck and cause undesirable premature shut-off situations.

### BRIEF SUMMARY OF THE INVENTION

The present invention is generally directed to an anti-siphonable inlet check valve (ASICV) assembly for a fuel tank for admitting liquid fuel into the fuel tank through a filler neck while preventing a siphon tube or hose from entering the fuel tank and contacting the liquid fuel. The component parts of the ASICV assembly are simple and economical to manufacture, assemble, and use.

More particularly, a valve assembly is provided in one aspect of the invention for admitting fuel into a fuel tank. The valve assembly includes a housing with an inlet and an inner surface, which has an opening for passage of liquid fuel into a fuel tank interior. An anti-siphon device is attached to the inner surface between the inlet and the opening to block a siphoning device from passing through the opening into the fuel tank interior. In this aspect, the valve assembly also includes a piston arrangement with a piston element movable in the housing adjacent the inner surface. The piston element is normally urged in a first direction to close the opening. The anti-siphon device is tapered in cross-section to permit the liquid fuel to contact and move the piston element in a second direction to open the opening to allow the liquid fuel to pass through the opening into the fuel tank interior without effecting splashback that can induce a pressure change in the housing and cause premature shut-off of fuel filling.

According to another aspect of the invention, an anti-siphonable inlet check valve for a fuel tank filler neck includes a housing with an inlet for passage of a liquid fuel, and a valve located in the housing to open and close the housing to a fuel tank interior. The valve can be any form of butterfly, flap or other static or dynamic valve. Also in this aspect, an anti-siphon device is located in the housing to prevent a siphoning device from entering the fuel tank interior. The anti-siphon device defines a hydrodynamic cross-section to deliver the liquid fuel in a direction of the valve to open the housing and pass the liquid fuel into the fuel tank interior without causing splashback of the liquid fuel, such that an adverse pressure change is effected above the valve in the housing to adversely affect fuel filling.

In still other aspects of the invention, the anti-siphon device is a rib tapered in cross-section, more particularly, teardrop-shaped. If more than one rib is utilized, the ribs are spaced apart from each other at a width less than a diameter of the siphoning device so the siphoning device cannot enter the fuel tank interior. The ribs can be unitarily molded in the housing or snapped into respective slots defined in the housing. Additionally, the ribs can be disposed axially apart from another set of ribs transverse to each other to form a grid-like structure that prevents passage of the siphoning device but allows substantially uninterrupted fuel flow into the fuel tank interior.

Other advantages of the invention will be apparent from the following description and the attached drawings or can be learned through practice of the invention.

### BRIEF DESCRIPTION OF THE DRAWINGS

The above and other aspects and advantages of the present invention are apparent from the detailed description below and in combination with the drawings in which:

FIG. 1 is a partially broken away, perspective view of a vehicle fuel system with an anti-siphonable inlet check valve installed in a filler neck of a vehicle fuel tank according to an aspect of the invention;

FIG. 2a is a partial, cross-section perspective view of the anti-siphonable inlet check valve as in FIG. 1 particularly showing hydrodynamically contoured ribs disposed in the anti-siphonable inlet check valve in accordance with certain aspects of the present invention;

FIG. 2b is a partial, cross-section elevation view of the ribs as in FIG. 2a showing a liquid fuel flow past the ribs;

FIG. 3a is a partial, top perspective view of the anti-siphonable inlet check valve as in FIG. 2a;

FIG. 3b is a partial, cross-section perspective view taken along lines 3B-3B of FIG. 3a;

FIG. 4a is a top perspective view similar to FIG. 3a showing an alternative embodiment of the invention;

FIG. 4b is a partial, cross section perspective view taken along lines 4B-4B of FIG. 4a;

FIG. 5 is a perspective transparent view of the anti-siphonable inlet check valve showing the ribs as in FIG. 2a obstructing a siphon hose from an interior of the vehicle fuel tank; and

FIG. 6 is a perspective view of an anti-siphonable inlet check valve with an anti-siphon device in accordance with another aspect of the present invention.

### DETAILED DESCRIPTION OF THE DRAWINGS

Detailed reference will now be made to the drawings in which examples embodying the present invention are shown. The detailed description uses numerical and letter designations to refer to features in the drawings. Like or similar designations in the detailed description and the drawings have been used to refer to like or similar parts of the invention.

The drawings and detailed description provide a full and detailed written description of the invention and the manner and process of making and using it, so as to enable one skilled in the pertinent art to make and use it. The drawings and detailed description also provide the best mode of carrying out the invention. However, the examples set forth herein are provided by way of explanation of the invention and are not meant as limitations of the invention. The present invention thus includes modifications and variations of the following examples as come within the scope of the appended claims and their equivalents.

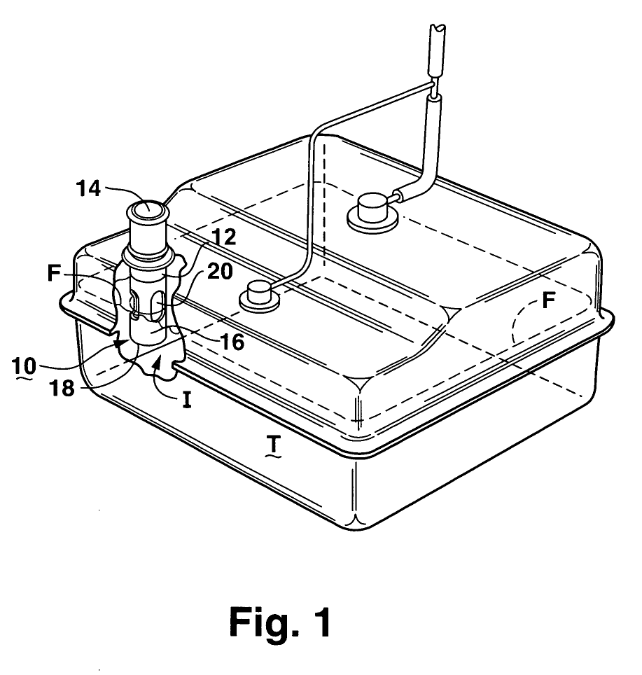

As broadly embodied in FIG. 1, an anti-siphonable inlet check valve (ASICV) assembly for a fuel tank T is designated in general by the number 10. The ASICV assembly 10 is attached to the fuel tank T to provide a liquid fuel path from a filler nozzle (not shown) to an interior I of the fuel tank T for filling the fuel tank T with the liquid fuel F.

As shown, the ASICV assembly 10 generally includes a housing 12 with an inlet 14 and a frame end 16 that forms at least one aperture 18. One or more openings 20 are also formed in the housing 12. As discussed in detail below, an anti-siphon device is attached within the housing 12 to permit the liquid fuel F to pass substantially unimpeded through the ASICV assembly 10 into the interior I of the fuel tank T via the apertures 18 or the openings 20. Accordingly, the housing 12 is made of polyoxymethylene (POM), nylon, or other materials suitable for substantially constant contact with the liquid fuel F and its vapor.

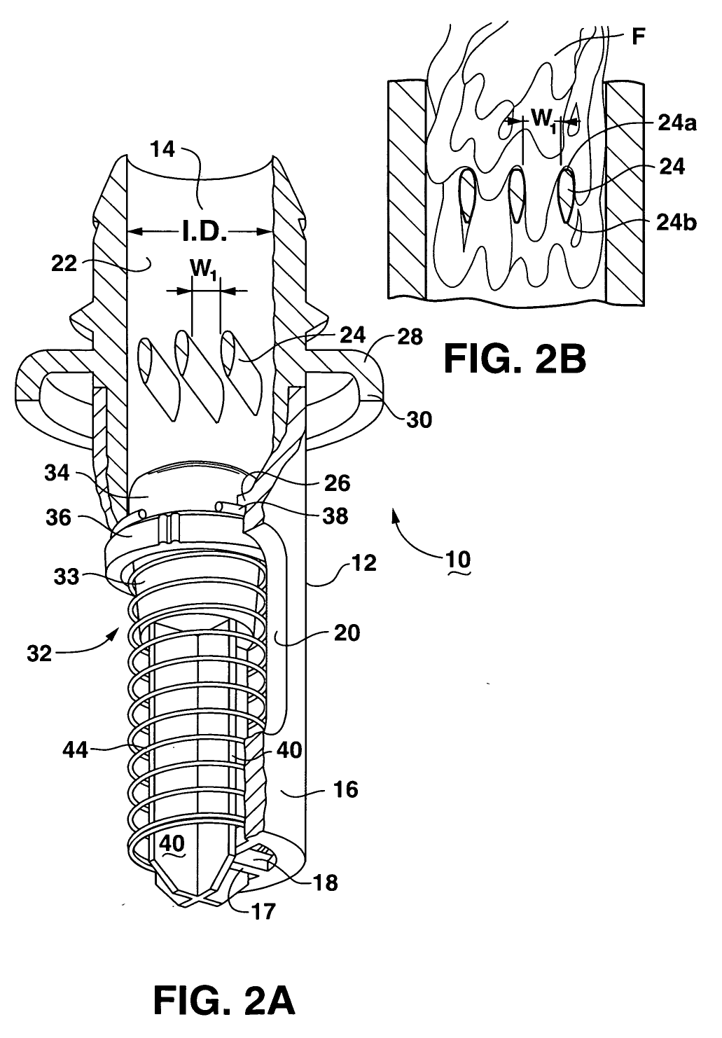

FIGS. 2a and 2b show one possible arrangement for the ASICV assembly 10. As shown, guide bars 17 are attached on the frame end 16 of the housing 12 to form the apertures 18 and axially control a guide 40, discussed further below. The housing 12 further defines an inner surface 22 having an inner diameter I.D. across which the anti-siphon device is attached.

In this aspect of the invention, the anti-siphon device is a plurality of ribs 24 attached in the housing 12 to prevent a foreign object such as a siphoning device, hose or tube D from entering the fuel tank T and contacting the liquid fuel F in the interior I. In this example, the ribs 24 are unitarily molded with a high-density polyurethane (HDPE) weld pad 28 depending from the housing 12. Alternatively, the ribs 24 can be formed within an insert (not shown) and overmolded with the HDPE weld pad 28. The ribs 24 can also be mechanically affixed to the insert by snapping the ribs 24 in place using a wedge or key system. These ribs 24 and methods of attaching them within the housing 12 are described in greater detail and by example operation below.

With particular reference to FIG. 2a, a shoulder element 26 is shown spaced axially apart from the ribs 24 also depending from the inner surface 22. Also shown, the weld pad 28 defines a weld foot 30 for attachment to a surface of the fuel tank T as shown in FIG. 1. By way of example and not limitation, the weld foot 30 can be attached to the fuel tank T in a manner as described in U.S. patent application Ser. No. 10/356,380. Those skilled in the art will appreciate that the ASICV assembly 10 can be attached to the fuel tank T in a variety of other manners, and therefore further explanation is not necessary to understand and practice this aspect of the invention.

FIG. 2a further shows a valve or piston arrangement 32 including a piston element 33 with an elevated surface 34, a catch 36, a sealing element 38 and the guide 40 as introduced. A spring 44 is disposed about the piston element 33 for urging the piston element 33 against the shoulder element 26 of the ASICV assembly 10 such that the catch 36 of the piston element 33 presses the sealing element 38 against the shoulder element 26 to normally seal the openings 20 in a closed condition.

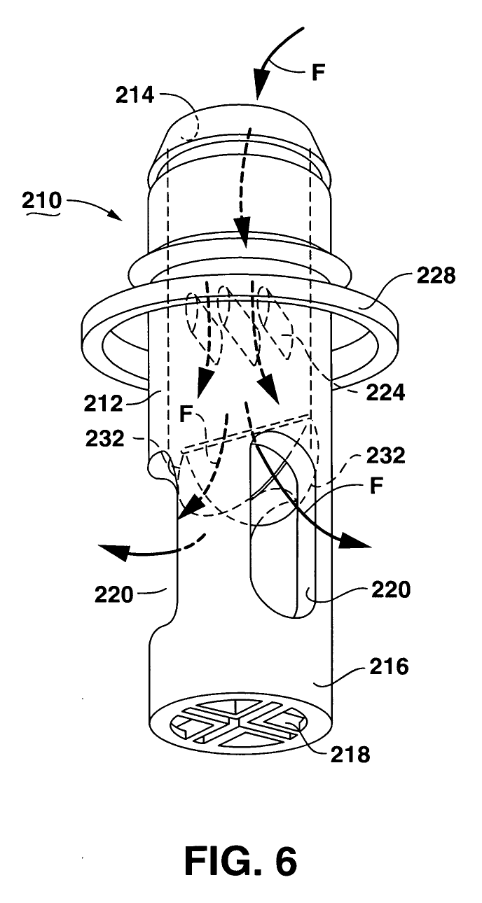

For reasons described in detail below, the liquid fuel F will pass the ribs 24 substantially unimpeded and undisturbed with sufficient force to compress the piston element 33 such that the fuel F exits through the apertures 18 and the openings 20 into the interior I of the fuel tank T. By way of example, U.S. Pat. No. 6,648,016 B2 describes a device similar to the exemplary piston arrangement 32; thus, reference is made thereto to understand and practice this aspect of the invention. Those skilled in the art will appreciate, however, that the ribs 24 can be placed above any sealing surface of any valve housing that employs other check valve arrangements other than the exemplary piston arrangement 32. For instance, a flap valve 232 as shown in FIG. 6 and discussed below can be substituted for the piston arrangement 32.

As shown most clearly in FIG. 2b, the ribs 24 are substantially parallel and spaced apart from each other by a respective spacing or width W₁. Each rib 24 defines a leading edge or upper surface 24a and a lower or terminating surface 24b. The three ribs 24 shown in this aspect of the invention exhibit an inverted teardrop, wing, taper, convex-convex, or cat's eye shape. So formed, the streamlined ribs 24 reduce fluid resistance as the fuel F flows across the surfaces 24a,b. More specifically, the relatively wider upper surfaces 24a and the relatively narrower terminating surfaces 24b hydrodynamically contour the ribs 24 to facilitate smooth flow of fuel F. As described by example operation below, the ribs 24 thus prevent spray or splashback in the ASICV assembly 10. Those skilled in the art will appreciate that the ribs 24 in this embodiment thus both block foreign siphoning devices and facilitate smooth fuel flow; however, in order to block the foreign siphoning devices, the ribs 24 are not limited to the streamlined shapes described above.

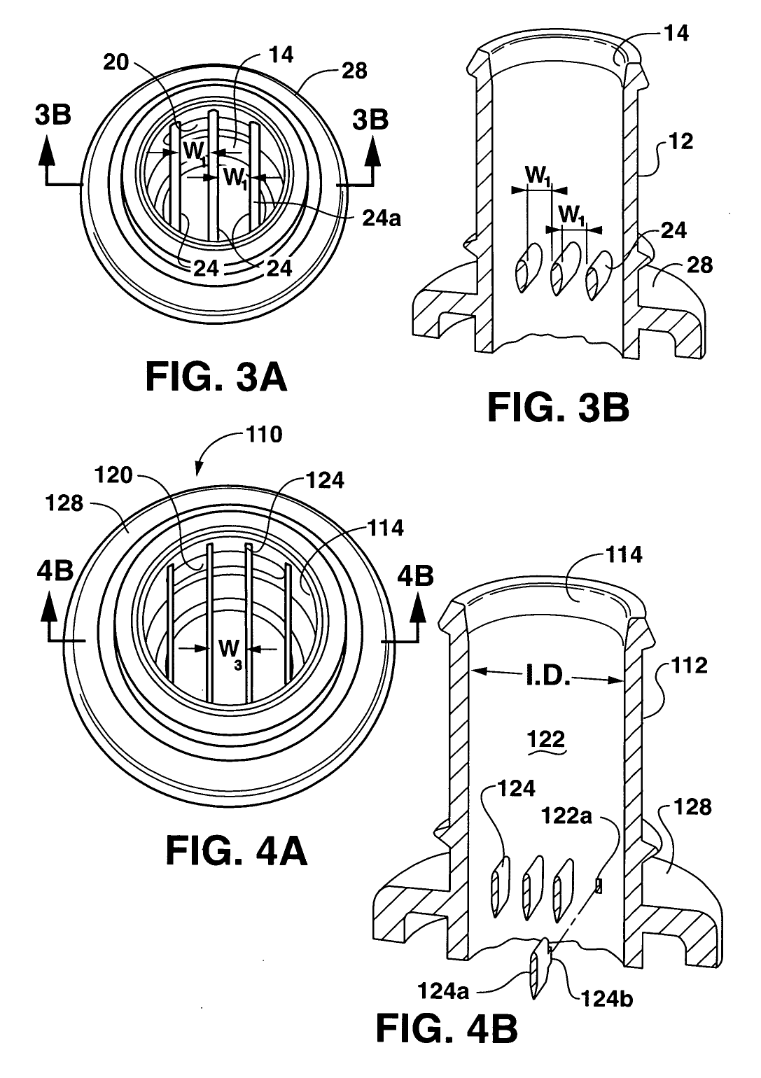

FIGS. 3a and 3b most clearly show the plurality of ribs 24, their respective leading and terminating surfaces 24a, 24b, and the width W₁ between each of the ribs 24. As discussed below, the width W₁ is sufficient to prevent the siphon tube D having a diameter of at least 5.2 millimeters (mm) and a length of not less than 1200 mm from being extended past the ribs 24 into the fuel tank interior I and contacting the fuel F.

FIG. 4a shows another embodiment of the invention in which four wings or ribs 124 are disposed in an antisiphonable inlet check valve (ASICV) assembly 110. This embodiment is similar in some ways to the foregoing embodiment. Therefore, only certain elements of this embodiment are described below to avoid repetition with reference being made to the foregoing embodiment for like and similar elements to understand and practice this aspect of the invention.

As shown in FIGS. 4a and 4b, the four ribs 124 are spaced apart from each other by a distance W₃. The ribs 124 are relatively thinner or narrower than the ribs 24 in the previous embodiment. The spacing W₃, however, remains less than the diameter W₁ of the siphon hose D as described above. Therefore, the siphon hose D is unable to pass by the ribs 124 in this embodiment according to the principles previously discussed. Briefly, the ribs 124 define an inverted teardrop shape similar to the previous embodiment such that liquid fuel F will flow past the ribs 124 in a manner as shown in FIG. 2b with minimal disruption, and therefore, with minimal pressure drop in the ASICV assembly 110 caused by turbulent fuel F passage.

FIG. 4b shows an additional aspect of the invention including a rib 124a and a complementary slot 122a formed in an inner wall 122 of a housing 112 of the ASICV assembly 110. As indicated by a dashed line, the rib 124a is inserted, snapped or wedged into the slot 122a. In this example, the rib 124a defines a key 124b protruding from an end of the rib 124a that is snapped into the slot 122a to hold the rib 124a firmly in position in the housing 112. One skilled in the art will appreciate that an opposing key (not shown) is formed on an opposing end of the rib 124a to anchor the opposing end in an opposing side of the inner wall 122. It will be further appreciated that keys with various dimensions or shapes, or wedge-shaped ends of the rib 124a, can be used to anchor the rib 124a in the wall 122. Thus, in this aspect of the invention, a preformed housing with slots therein can be subsequently equipped with ribs having different dimensions than those illustrated. For instance, in lieu of unitarily molded ribs and housings, wider ribs can be snapped in respective slots in pre-formed housings to meet on-demand requirements from customers.

The invention may be better understood with reference, for instance, to FIG. 2b and to an example operation of the invention. Reference is also made to principles of fluid mechanics and Bernoulli's law, which describes the behavior of a fluid under varying conditions.

Briefly, Bernoulli's law states:
P+½ρv²+ρgh=[constant],

where P is the static pressure (in Newtons per square meter), ρ is the fluid density (in kg per cubic meter), v is the velocity of fluid flow (in meters per second), g is a gravitational constant, and h is the height above a reference surface. The second term in the equation is known as the dynamic pressure. Dynamic pressure is the component of fluid pressure that represents fluid kinetic energy (i.e., motion), while static pressure represents hydrostatic effects, so
Pₜₒₜₐₗ=P_{dynamic}+P_{static}.

The dynamic pressure of a fluid with density p and speed u is given by:
P_{dynamic}=½ρu², i.e., the second term in Bernoulli's law.

Simply stated, the quantity of an incompressible fluid is constant along any streamline. Therefore, for example, where the dynamic speed u of the fluid decreases due, for instance, to a restricted area in the streamline, pressure P must increase to maintain the Bernoulli constant.

As shown in FIG. 2b, as fuel F flows into the ASICV assembly 10 via the inlet 14, the fuel F contacts the upper surfaces 24a of the ribs 24 and flows smoothly past respective terminating surfaces 24b of the ribs 24. This hydrodynamic arrangement provides an overall rib surface area that is substantially less than open space surrounding the overall rib surface area. In other words, the ribs 24 restrict the surrounding open space as little as possible.

The hydrodynamically contoured ribs 24 are similar to an aerodynamic airfoil or airplane wing that operates according to the principles of fluid mechanics. The airplane wing is designed to reduce air resistance of an air stream flowing over and around the wing as the airplane wing passes through the air stream. This reduced air resistance allows the air stream to separate smoothly and flow across a thicker leading edge of the wing and merge and depart a thinner trailing edge of the wing without creating vortices or ripples in the air stream. With the air stream left relatively undisturbed, the wing and the airplane itself are not buffeted, and fuel efficiency and maximum airspeed are attained.

As shown in FIG. 2b, the ribs 24 and the fuel F cooperate respectively like the airplane wing in the air stream. In this aspect of the invention, the fuel F contacts the leading edge 24a of the ribs 24, smoothly separates, flows across the ribs 24, and departs substantially turbulent-free from the trailing edge 24b. Such undisturbed fluid flow prevents pressure changes and/or splashback in the ASICV assembly 10, which can lead to unwanted fuel filling shut-off situations.

Although liquid splashback will not physically reach the filler nozzle in most filler necks, if the liquid fuel is sufficiently impeded above or through an inlet check valve, the splashback will create a pressure differential and may trigger a nozzle shut-off sensor.

Those skilled in the art will appreciate that the ribs 24 can be spaced and contoured according to various original equipment manufacturer requirements, which may dictate more or less fuel flow under other ambient pressures.

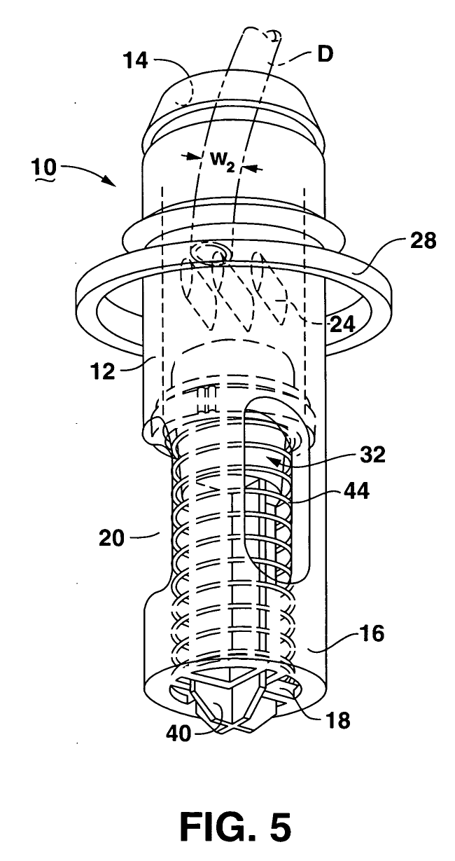

FIG. 5 shows another example of the ASICV assembly 10 in operation. As shown, the siphon tube D is inserted into the inlet 14 of the ASICV assembly 10. The ribs 24, however, prevent the siphon tube D from contacting the piston arrangement 32 to compress the spring 44 and pass into the fuel tank interior via the openings 20.

More specifically, the siphon hose D in FIG. 5 has a diameter or width W₂ greater than 5.2 mm. Therefore, W₁, which is less than W₂ between the ribs 24, prevents the siphon hose D from passing through the ribs 24. It will be understood that the number, size, and spacing between the ribs 24 can be varied to accommodate manufacturing requirements or government regulations; e.g. the spacing W₁ can be further reduced to prevent smaller diameter siphon hoses D from passing by the ribs 24. Stated another way, any number and size of contoured ribs 24 can be provided in which W₁ of the ribs 24 is less than W₂ of the siphon hose D.

As noted above, the ribs 24 can be placed above any sealing surface of any valve housing that employs other check valve arrangements other than the exemplary piston arrangement 32. As shown in FIG. 6, for example, the flap valve 232 briefly introduced with respect to FIG. 2a above can be substituted for the piston arrangement 32. This embodiment is similar in some ways to the foregoing embodiments; therefore, reference is made to the foregoing embodiments for like and similar elements to understand and practice similar aspects of the invention.

Briefly, as shown in FIG. 6, fuel F enters an inlet 214 of the valve assembly 210 and flows past a plurality of ribs 224 with minimal disruption as outlined above. The fuel F contacts the flap valve 232 with sufficient force to urge the flap valve 232 open. The fuel F therefore exits the valve assembly 210 through at least one window 220.

One skilled in the art will appreciate that the exemplary ribs described herein can be any frame or grid shape exhibiting a hydrodynamic profile that simultaneously reduces fuel flow disruption (e.g., reduces splashback) and agitation (reduces cavitation) while preventing siphon devices from entering the fuel tank T through the ASICV assembly 10, which could contaminate or spill the liquid fuel F. For instance, the ribs 24, 124, 224 may be disposed above or below another set of ribs 24, 124, 224 in a transverse, intersecting or cross-like arrangement viewed in an axial direction within the ASICV assembly 10, 110, 210 such that a grid-like structure is formed.

Moreover, the ribs described herein and alternative embodiments within the scope and spirit of this invention can be extruded or molded, for instance, unitarily with the ASICV assembly of the present invention to ensure the integrity of the ribs with the ASICV assembly such that the ribs or alternative embodiments thereof will not separate from the ASICV assembly. For instance, should someone attempt to siphon the liquid fuel F via the ASICV assembly 10 with the siphon hose D and should that person contact the ribs 24 with sufficient force, the unitarily molded ribs 24 will ensure that the ribs 24 do not break away from the ASICV assembly 10 and damage the piston arrangement 32 or some other valve and/or otherwise obstruct the ASICV assembly 10 and/or fall into the interior I of the fuel tank T.

While examples of the invention have been shown and described, those skilled in the art will recognize that other changes and modifications may be made to the foregoing embodiments without departing from the spirit and scope of the invention. For example, specific shapes and dimensions of various elements are illustrated and described herein but may be altered to suit particular applications. It is intended to claim all such changes and modifications as fall within the scope of the appended claims and their equivalents. Moreover, references herein to “top,” “lower,” “bottom,” “upward,” “downward,” “descending,” “ascending,” “upper,” and “side” structures, elements, geometries and the like are intended solely for purposes of providing an enabling disclosure and in no way suggest limitations regarding the operative orientation of the exemplary embodiments or any components thereof.

That which is claimed is:

1. A valve assembly for admitting fuel into a fuel tank, the valve assembly comprising:
a housing defining an inlet and an inner surface therein, the inner surface defining an opening therethrough for passage of liquid fuel into a fuel tank interior;
an anti-siphon device attached to the inner surface disposed between the inlet and the opening to block a siphoning device from passing through the opening into the fuel tank interior; and
a piston arrangement having a piston element movable in the housing adjacent the inner surface, the piston element urged in a first direction to close the opening, the anti-siphon device tapered in cross-section to permit the liquid fuel to contact and move the piston element in a second direction to open the opening and allow the liquid fuel to pass through the opening into the fuel tank interior without effecting splashback such that a pressure change is induced in the housing to shut-off fuel filling prematurely.

2. The valve assembly of claim 1, wherein the anti-siphon device is at least one rib depending across an inner diameter of the inner surface, the rib wing-shaped to facilitate hydrodynamic flow of the liquid fuel across the rib.

3. The valve assembly of claim 1, wherein the anti-siphon device is at least one rib depending across an inner diameter of the inner surface, the rib defining a convex-convex shape in cross-section to facilitate flow of the liquid fuel across the rib.

4. The valve assembly of claim 3, further comprising a plurality of the ribs spaced parallel to each other and apart no greater than about 5.2 millimeters to prevent the siphoning device from passing between any two of the ribs.

5. The valve assembly of claim 1, wherein the anti-siphon device is a grid-like structure of intersecting ribs each tapered in cross-section.

6. The valve assembly of claim 1, wherein the anti-siphon device presents a surface area less than an open space adjacent the surface area.

7. An anti-siphonable inlet check valve for a fuel tank filler neck comprising:
a housing having an inlet and a valve, the inlet configured for passage of a liquid fuel, the valve disposed in the housing configured for opening and closing the housing to a fuel tank interior; and
an anti-siphon device disposed in the housing to prevent a siphoning device from entering the fuel tank interior, the anti-siphon device defining a hydrodynamic cross-section to deliver the liquid fuel in a direction of the valve to open the housing and pass the liquid fuel into the fuel tank interior without causing splashback of the liquid fuel, such that an adverse pressure change is effected above the valve in the housing to adversely affect fuel filling.

8. The anti-siphonable inlet check valve of claim 7, wherein the housing and anti-siphon device are formed unitarily of POM or nylon.

9. The anti-siphonable inlet check valve of claim 7, wherein the anti-siphon device is at least one rib tapered in cross-section.

10. The anti-siphonable inlet check valve of claim 9, further comprising a plurality of the ribs spaced apart from each other at a width less than a diameter of the siphoning device.

11. The anti-siphonable inlet check valve of claim 7, wherein the liquid fuel contains alcohol.

12. An anti-siphoning device for a filler neck of a vehicle fuel tank, the anti-siphoning device comprising:
a housing disposed in a fuel tank with a plurality of ribs disposed in the housing, each rib teardrop-shaped in cross section and configured to prevent passage of a siphoning device into a fuel tank interior, the teardrop-shaped ribs affixed in the housing to resist separation therefrom, the teardrop-shaped ribs further configured to permit passage of a liquid fuel through the housing into a fuel tank without creating an adverse pressure differential in the housing.

13. The anti-siphon device as in claim 12, wherein the ribs are wider in cross-section in a direction of an opening of the filler neck and narrower in cross-section in a direction of the fuel tank interior.

14. The anti-siphon device as in claim 12, wherein the ribs are spaced apart from each other at a width of W₁, the siphoning device defines a width of W₂, and wherein W₁<W₂.

15. The valve assembly of claim 12, wherein the ribs are spaced parallel to each other and apart no greater than about 5.2 millimeters to prevent the siphoning device from passing between any two of the ribs.

16. The anti-siphon device as in claim 12, wherein the ribs are unitarily molded in the housing.

17. The anti-siphon device as in claim 12, wherein the ribs are snapped into respective slots defined in the housing.

18. The anti-siphon device as in claim 12, further comprising a plurality of transverse ribs disposed axially apart from the plurality of ribs, the transverse ribs and the ribs forming a grid-like structure.
